(19) United States
(12) Patent Application Publication
(10) Pub. No.: US 2012/0251681 A1
(43) Pub. Date: Oct. 4, 2012

(54) Method and Production Plant for Manufacturing a Beverage Product

(75) Inventor: Jörg Zacharias, Koefering (DE)

(73) Assignee: KRONES AG, Neutraubling (DE)

(21) Appl. No.: 13/428,009

(22) Filed: Mar. 23, 2012

(30) Foreign Application Priority Data
Mar. 31, 2011 (DE) 10 2011 006 547.4

(51) Int. Cl. A23L 2/42; A23L 2/50; A23L 2/44; A23L 1/00; A23L 2/74

(52) U.S. Cl. 426/238; 99/275; 426/519; 426/490; 426/330.3; 426/240; 426/248

(57) ABSTRACT

A method of manufacturing a beverage product, including mixing at least two product flows, wherein at least one of the at least two product flows is sterilized before mixing without heating.

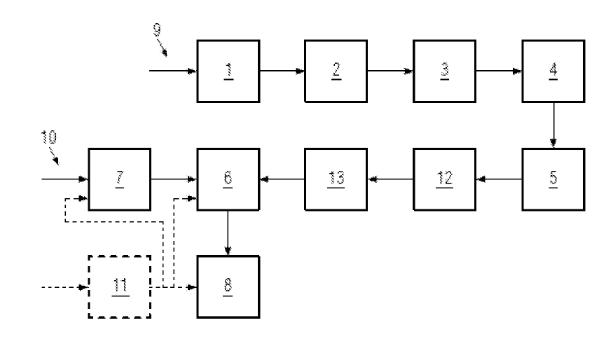

### CROSS-REFERENCE TO RELATED APPLICATION

The present application claims the benefit of priority of German Application No. 102011006547.4, filed Mar. 31, 2011. The entire text of the priority application is incorporated herein by reference in its entirety.

### FIELD OF THE DISCLOSURE

The disclosure relates to a method and a production plant for manufacturing a beverage product.

### BACKGROUND

In beverage production, the preservation of the produced beverage plays a decisive roll. Preservation is usually achieved by thermal sterilization, that means by heating the beverage. Depending on the initial contamination and the requirements as to the best before date, here the reduction of the number of reproducible microorganisms by a certain factor is achieved.

Beverage products are often produced by mixing different ingredients or product flows. For example, soft drinks or carbonated soft drinks are usually produced by mixing juices from concentrates with water.

The components are mixed in mixing tanks, static mixers, on separate filler carousels or predosers, respectively, or directly during filling. The individual components and/or the finished product are sterilized by heating.

In the standard process for sterilization, a vapor or a hot-water heated, ultra-high temperature (UHT) device is employed. Characteristic temperatures are here 121° C., 130° C. or even up to 140° C. The temperature profile required for killing microorganisms is usually monitored by means of temperature sensors.

A disadvantage of the known manufacturing processes, however, is that for thermal heat treatment, that means for heating, a high amount of thermal energy must be employed.

### SUMMARY OF THE DISCLOSURE

One aspect of the present disclosure is to provide a more energy efficient method and a more energy efficient production plant for manufacturing a beverage product.

The disclosure provides a method of manufacturing a beverage product, comprising mixing at least two product flows, wherein at least one of the at least two product flows is sterilized before mixing without heating.

By at least one of the at least two product flows being sterilized without heating or free from heating, energy consumption during the manufacture of the beverage product can be reduced.

The beverage product can be, for example, a soft drink (SD) or a carbonated soft drink (CSD).

The at least two product flows can in particular comprise a juice and/or syrup flow, a slurry flow, a flavor flow, a mineral and/or salt flow, and/or a water flow.

In particular the water flow can be sterilized without heating.

Sterilization can here in particular be understood as a reduction of the number of reproducible microorganisms. The number of reproducible microorganisms or germs can here be reduced by a predetermined factor.

Mixing the at least two product flows can be accomplished aseptically. By this, further sterilization of the mixed total flow can be avoided, permitting to save further energy.

In particular, more than one, in particular all product flows, can be sterilized without heating or free from heating.

The at least one product flow, that means the product flow to be sterilized free from heating or in a cold aseptic manner, can be sterilized by means of a membrane filter and/or by means of chemical disinfectants and/or by means of electromagnetic radiation and/or by means of ultrasonic sound.

One can thus obtain a cold aseptic beverage production method as an alternative to the common pasteurization and sterilization methods in industrial beverage production.

In case of sterilization by means of a membrane filter, that means in case of sterile filtration, this can in particular be ultrafiltration. A filtration method where particles of a size, in particular a mean diameter, of greater than 0.1 μm to 0.01 μm can be separated or extracted can be referred to as ultrafiltration. The membrane filter can have a mean pore size of 0.01 μm to 0.45 μm, in particular of 0.02 μm to 0.2 μm, in particular of 0.01 μm to 0.1 μm.

The membrane filtration module can in particular comprise a hollow fiber membrane filter. The hollow fiber membrane filter can comprise some hundred to some thousand hollow fiber membranes, in particular with a mean pore size of 0.2 μm to 0.45 μm, in particular of 0.2 μm to 0.02 μm, in particular of 0.1 μm to 0.01 μm.

As a chemical disinfectant, ozone can be used in particular. Ozone decomposes or is easily removable thus not representing critical pollution in the beverage product. However, other disinfectants, as for example chlorine dioxide, hydrogen peroxide or singlet oxygen, are also possible. Optionally, combinations of disinfectants can also be used.

Sterilization by means of electromagnetic radiation can comprise ionizing or non-ionizing radiation. As ionizing radiation, x-ray, gamma or electron beam radiation can be used, for example. As non-ionizing radiation, for example ultraviolet radiation is possible.

The at least one product flow to be sterilized without heating can comprise a temperature between 5° C. and 45° C., in particular between 10° C. and 20° C.

The at least one product flow can in particular be a cold water flow, that means, for example, fresh water in the form of raw water or purified water. In other words, the at least one product flow can comprise water with a temperature between 5° C. and 45° C., in particular between 10° C. and 20° C., or correspond to such water.

The at least one product flow can be the main product flow or main branch. In other words, the proportion of the component supplied in the at least one product flow can be in the produced beverage product between 50% and 70%, in particular between 50% and 90%, in particular between 50% and 99%.

The at least one product flow can be conditioned or treated before sterilization, in particular with respect to the pH value and/or salt content.

As an alternative or in addition, substances for forming agglomerates can be also added to the at least one product flow before sterilization. These can be used for the selective separation of certain pollutants.

As an alternative or in addition, tracer molecules can also be added. If these can still be detected after sterilization, this can be an indication of faults in the sterilization, for example of a membrane fracture.

The method can moreover comprise monitoring the sterility of the at least one product flow.

The sterility of the at least one product flow can be monitored by means of a sensor, in particular an online sensor. By this, the security of the manufacturing process of the beverage product can be increased.

One can in particular understand, as an online sensor, a sensor which permits the sterility of the at least one product flow during the manufacture of the beverage product, that means in particular without interruption of the production.

The sterility of the at least one product flow can be checked with the aid of the sensor before the at least two product flows are mixed. The sensor can in particular monitor or check the sterility of the product flow sterilized free from heating.

A disinfectant can be added to the at least one product flow, in particular continuously, and the reduction of concentration of the disinfectant can be determined and evaluated directly in the production flow. The disinfectant can in particular be added to the product flow sterilized free from heating. In other words, the product flow can be first sterilized without heating and the disinfectant can be added then, in particular independent of whether the sterilized product flow is actually sterile or contaminated, and then the reduction of concentration can be determined and evaluated directly in the production flow.

So, the disinfectant is here not primarily used for disinfecting the product flow but to be able to find out, by way of the evaluation of the reduction of concentration in the product flow, whether the production plant operates properly during the manufacturing process or whether a malfunction occurs. With a proper function of the production plant, an exactly predeterminable, relatively small reduction of concentration of the disinfectant occurs (also referred to as half-life period), while in case of a malfunction, a considerably more significant reduction of concentration occurs due to the contamination as a consequence of the destruction of microorganisms by the disinfectant, so that then an immediate conclusion to a malfunction is possible and counter-measures can be initiated.

By using such a sensor or sterile sensor, one can easily provide a permanent sterility evidence also for a product flow sterilized without heating.

If a membrane filtration module is used, in particular for ultrafiltration, the employed membrane type does not have to be resistant to the added disinfectant as the latter is only added in the product flow downstream of the membrane filtration module.

If the sensor detects a malfunction, the production plant can be shut down, that means the manufacture of the beverage product can be stopped, or a warning signal or a warning message can be emitted to an operator.

The product flow blended with the disinfectant can be in particular conducted through a dwell section, wherein the disinfectant concentration is measured before and after the dwell section, and/or a disinfectant concentration difference is determined and evaluated, and in particular wherein the manufacture of the beverage product can be either continued when sterility evidence is provided, or the added concentration can be increased as no sterility evidence is provided until sterility evidence can be provided, or the process is interrupted as no sterility evidence can be provided.

It is also possible to check the sterility of several, in particular of all product flows with one sensor each. Each of the sensors can comprise one or several ones of the above-described features.

It is also possible to provide several sensors for one product flow.

The sensor can also be employed in combination with further sensors, for example conductivity sensors, turbidity sensors, color sensors and/or spectrophotometric systems. So, redundant information for securing online measurement can be consulted on the one hand. On the other hand, unclear measured values can be evaluated more clearly and sensitively by the combination of the information.

The disclosure moreover provides a production plant for the manufacture of a beverage product, including:

a mixing device for mixing at least two product flows, and

a sterilization device for sterilizing at least one of the at least two product flows free from heating.

By the sterilization device permitting sterilization of at least one of the at least two product flows free from heating, it is possible to save energy compared to sterilization by heating.

In other words, the production plant can be designed and/or configured such that an above mentioned method of manufacturing a beverage product can be performed in it.

The sterilization device can in particular include at least one membrane filtration module. The membrane filtration module can in particular include one or several ones of the above mentioned features. The sterilization device can, as an alternative or in addition, include a device for introducing a chemical disinfectant and/or electromagnetic radiation and/or ultrasonic sound into the at least one product flow to be sterilized free from heating. The chemical disinfectant and/or electromagnetic radiation can in particular include one or several ones of the above mentioned features.

The at least one product flow which can be sterilized by the sterilization device free from heating can in particular include one or several ones of the above mentioned features, in particular correspond to a cold water flow.

The production plant can moreover provide a conditioning device for conditioning the at least one product flow before sterilization, in particular in view of the pH value and/or the salt content.

As an alternative or in addition, one can also add substances for the formation of agglomerates to the product flow in the conditioning device. These can be used for the purposeful separation of certain pollutants.

As an alternative or in addition, tracer molecules can also be added in the conditioning device. If these are still detected after sterilization, this can serve as an indication of malfunctions in sterilization, for example of a membrane fracture.

The production plant can moreover include a sensor for monitoring the sterility of the at least one product flow, in particular where a reduction of concentration of a disinfectant added to the product flow can be permanently measured with the sensor and evaluated with respect to providing sterility evidence.

The sensor can in particular include one or several ones of the above mentioned features.

The sensor can in particular be arranged downstream of or after the sterilization device. It can be arranged there inline or in a bypass. The inline arrangement is more advantageous, such that the complete product flow passes the sensor. In case of a bypass arrangement, a portion of the product flow can be branched off, for example by means of a bypass line, and only this separate portion of the product flow can be conducted past the sensor.

A dwell section can be provided in the sensor for the at least one product flow, and in the region of the begin of the dwell section, an adding device for the disinfectant, in particular ozone, chlorine dioxide, hydrogen peroxide or singlet oxygen, can be provided, wherein the sensor comprises a downstream disinfectant end concentration sensor with the dwell section.

The production plant can also include several sensors for sterility monitoring. In particular, one sensor each can be provided for several, in particular all, product flows. The sensors can in particular include one or several ones of the above mentioned features.

### BRIEF DESCRIPTION OF THE DRAWING

Further features and advantages of the disclosure will be illustrated below with reference to the exemplary FIGURE. The drawing schematically shows an exemplary production plant for manufacturing a beverage product.

### DETAILED DESCRIPTION OF THE PREFERRED EMBODIMENT

Beverages, such as soft drinks or carbonated soft drinks, are often manufactured by mixing juices from concentrates. In the process, further components or ingredients are added to the water as the main medium. Possible additional components can be macro- or micro-components in different quantities or quantitative proportions, for example concentrates (juice, syrup), slurry (fibers, pulps, particles and fruit pieces of any type), flavors, minerals and/or salt, etc.

The FIGURE schematically shows an exemplary production plant for manufacturing a beverage product. Here, two exemplary product flows 9 and 10 are mixed in a mixing device 6. The product flow 9 can in particular be a water flow. In particular, the water can be cold, that means it can have a temperature between 5° C. and 45° C.

The product flow 9 can be the main product flow or the main branch. In other words, the proportion of the component supplied in the product flow 9 in the produced beverage product can be between 50% and 70%, in particular between 50% and 90%, in particular between 50% and 99%. The second product flow 10 can be, for example, a concentrate flow. In other words, for example a fruit juice concentrate can be introduced into the mixing device 6 via the product flow 10. The beverage product produced in the mixing device 6 by mixing the two product flows can then be filled into containers, for example bottles, in a filling device 8.

The water in the product flow 10 can be initially treated in a water conditioning device 1. In the process, the water can be conditioned with respect to its pH value and/or salt content. The product flow can then be introduced into a sterilization device 2 in which the product flow is sterilized without being heated. The sterilization device 2 can in particular be an ultrafiltration plant in which the product flow, in particular the water flow, is sterilized by sterile filtration. In the process, microorganisms are separated from the water by filtration.

The device 1 can, as an alternative or in addition, also be used for adding substances for forming agglomerates and thus be utilized for the purposeful separation of certain pollutants. As an alternative or in addition, in the device 1, tracer molecules can also be added. Here, a redundant detection of them in case of a membrane fracture in the element 3 would be possible. These molecules can consist, for example, of zerovalent metal-molecule agglomerates.

In ultrafiltration, employed membranes can be embodied as hollow fiber, plate and/or coiled membranes. The membrane materials can comprise different plastics, such as for example polyethersulfone, or ceramics, sintered metals, etc. In ultrafiltration technology, the correct operating state of the production plant or the membranes, respectively, is conventionally checked by the so-called integrity test before, and if desired also after a production cycle. In the process, the air permeability of the wetted membrane is determined by means of compressed air, e.g. sterile air, in a fixed pressure range according to the “bubble-point” test principle. The monitored adjusting pressure difference (transmembrane pressure) and its reduction over a fixed characteristic time interval is an informative indication of the integrity with the respectively present pore size of the wetted membrane. The test reacts very sensibly to defective membranes (membrane fracture). The integrity test requires uncoupling the respective membrane unit to be subjected to the integrity test in case of several membrane units working in parallel. So, the integrity test can only be carried out during a production standstill (standstill of the membrane unit), in most cases in connection with a preceding backflush cycle and/or a cleaning cycle or sterilization cycle. This means that in prior art, there is no possibility of detecting a malfunction arising after the last integrity test and to remove it or initiate a counter-measure during the production cycle.

In the exemplary production plant in the FIGURE, a sterile sensor 5 is therefore provided which automatically monitors sterility directly at the product flow 9 and provides sterility evidence, so that in case a malfunction occurs resulting in contamination, counter-measures can be immediately initiated. The sterile sensor 5 here measures a reduction of concentration of a disinfectant added to the product flow 9 for sterility evidence. Such a sensor is also known from DE 10 2010 041 827.7.

The disinfectant is, for example, ozone, while chlorine dioxide, hydrogen peroxide, singlet oxygen or similar disinfectants could also be used individually or in combination. The ozone is in this example introduced into the product flow 9 by an adding device 4 for the disinfectant. In case of ozone, for example an ozone generator can be provided which adds the produced disinfectant to the product flow via a venturi nozzle injector or a probe or the like with a certain concentration. In case of ozone, a concentration of about 0.5 ppm to 2.0 ppm, preferably 0.5 ppm to 1.0 ppm, can be used for example.

The purpose of the disinfectant is here not primarily to create sterility by killing microorganisms or germs, but to provide a possibility of online condition control of the produced sterile product flow during a production cycle.

In case of an ultrafiltration module, the sterilization device 2 can also comprise a backflush system and an integrity test device. The sterilization device 2, in particular a filtration module of the sterilization device 2, can in particular be sanitizing or sterilizing.

Although the disinfectant is primarily added for condition control and its reduction of concentration is measured, the disinfecting effect of the added disinfectant can be additionally utilized to continue the production cycle in case of an only minimal contamination in the product flow, for example if a minor error has occurred at an individual membrane, or only possibly existing weak growth has been entrained. The disinfecting effect of the disinfectant can compensate this minor pollution.

In case of major contamination, the decomposition of the disinfectant increases, i.e. the half-life period in the decomposition of the ozone concentration is reduced. The sterile sensor 5 responds to it and, for example, emits an alarm or causes the abortion of the manufacturing process or the rejection of the product flow. This is because a rough change means a significant membrane fracture or module error, or else a detaching, up to then not detectable nest of microorganisms or germs.

In case of ozone as the disinfectant, the latter decomposes according to its half-life period or can be destroyed or removed in an additional apparatus so that essentially no ozone residues remain in the produced beverage product.

In the main branch of the product flow 9, an optional element 3 can be moreover provided. In this element, for example one or several ones of the following steps can be performed:
additional disinfection by means of a series-connected disinfection unit, for example a UV unit.
As an alternative or in addition, here further possibly required chemical additives for subsequent water conditioning and/or additional disinfection can be added.
It is also conceivable to here detect the above mentioned tracer molecules that can be added by the device 1 by a suited sensor. This unit can be used alternatively or redundantly to the online sterile sensor 5.

Element 12 is also optional and can be, for example, a residual ozone destroyer which minimizes ozone concentration to below official limiting values. However, it can also be important in the sense of minimizing the oxidation potential of residual ozone to later juice, syrup and/or flavor components.

Then, an additional element 13 can be inserted which is used for water deaeration and has the job of minimizing oxygen concentration and bring it below the limiting values required for production. As an alternative or in addition, a water deaerator can also be integrated in an aseptic mixer.

The second product flow 10 represented in the FIGURE is sterilized in a second sterilization device 7. This can be, for example, sterilization by means of microwaves, ultrasonic sound, high-frequency radiation and/or ultrafiltration. However, it is also conceivable to sterilize the second product flow 10 thermally, that means by heating. The sterilized second product flow 10 is then conducted into the mixing device 6 where it is mixed with the first product flow 9 to produce the desired beverage product.

The mixing device 6 is in this example in particular an aseptic mixer. By this, the sterility of the produced beverage product can be ensured. The mixer can be a dual valve or consist of several individual stages, such as a predoser.

In addition to the two product flows 9 and 10, further product flows can also be provided. A third exemplary product flow is represented in the FIGURE as a dotted line. In this product flow, in particular a third sterilization device 11 can be provided. The third sterilized product flow 6 can then be either also conducted into the mixing device 6 and/or directly into the filler 8. The latter can be performed, for example, in case of flavors. The sterilized third product flow, however, can also be supplied to the second product flow 10, in particular upstream of the second sterilization device 7.

It will be understood that features mentioned in the above described embodiments are not restricted to these special combinations and are also possible in any other combinations.

1. A method of manufacturing a beverage product, comprising mixing at least two product flows, wherein at least one of the at least two product flows is sterilized before mixing without heating.

2. The method according to claim 1, wherein mixing the at least two product flows is carried out aseptically.

3. The method according to claim 1, wherein the at least one product flow is sterilized by means of one of a membrane filtration module, a chemical disinfectant, electromagnetic radiation, ultrasonic sound and a combination thereof.

4. The method according to claim 1, wherein the at least one product flow is a cold water flow.

5. The method according to claim 1, wherein the sterility of the at least one product flow is monitored by means of a sensor.

6. The method according to claim 5, wherein the sterility of the at least one product flow is checked with the aid of the sensor before mixing the at least two product flows are mixed.

7. The method according to claim 5, wherein a disinfectant is added to the at least one product flow, and the reduction of concentration of the disinfectant is determined and evaluated directly in the product flow.

8. The method according to claim 7, wherein the product flow blended with the disinfectant is conducted through a dwell section, wherein one of the disinfectant concentrations are measured before and after the dwell section, a disinfectant concentration difference is determined and evaluated, and a combination thereof and wherein the manufacture of the beverage product is one of continued when sterility evidence is provided, the addition of concentration is increased due to a not provided sterility evidence until sterility evidence can be provided, and the manufacture is stopped as no sterility evidence can be provided.

9. A production plant for manufacturing a beverage product, comprising:
a mixing device for mixing at least two product flows; and
a sterilization device for sterilizing at least one of the at least two product flows free from heating.

10. The production plant according to claim 9, wherein the sterilization device comprises at least one membrane filtration module.

11. The production plant according to claim 9, further comprising a sensor for monitoring the sterility of the at least one product flow.

12. The production plant according to claim 11, wherein a dwell section is provided for the at least one product flow at the sensor, and in the region of the begin of the dwell section, an addition device for the disinfectant is provided, and wherein the sensor comprises a disinfectant end concentration sensor downstream of the dwell section.

13. The method according to claim 5, wherein the sensor is an online sensor.

14. The method according to claim 7, wherein the disinfectant is added continuously.

15. The production plant according to claim 11, and wherein a reduction of concentration of a disinfectant added to the product flow can be permanently measured with the sensor and evaluated with respect to the provision of a sterility evidence.

16. The production plant according to claim 12, wherein the disinfectant comprises one of ozone, chlorine dioxide, hydrogen peroxide, and singlet oxygen.
